(19) United States
(12) Patent Application Publication
(10) Pub. No.: US 2024/0407454 A1
(43) Pub. Date: Dec. 12, 2024

(54) AEROSOL GENERATING DEVICE

(71) Applicant: KT&G CORPORATION, Daejeon (KR)

(72) Inventors: Sangkyu PARK, Seoul (KR); Jongsub LEE, Sungnam-si Gyeonggi-do (KR); Wooseok CHUNG, Namyangju-si, Gyeonggi-do (KR); Byungsung CHO, Gwangmyung-si, Gyeonggi-do (KR); Daenam HAN, Seoul (KR)

(73) Assignee: KT&G CORPORATION, Daejeon (KR)

(21) Appl. No.: 18/698,267

(22) PCT Filed: Oct. 18, 2022
(86) PCT No.: PCT/KR2022/015841

§ 371 Date: Apr. 3, 2024

(30) Foreign Application Priority Data
Oct. 19, 2021 (KR) 10-2021-0139803
Mar. 10, 2022 (KR) 10-2022-0030270

(51) Int. Cl. A24F 40/50; A24F 40/10; A24F 40/44

(52) U.S. Cl. CPC A24F 40/50; A24F 40/10; A24F 40/44

(57) ABSTRACT

An aerosol generating device is provided. The aerosol generating device according to the present disclosure includes: a main body; a container shaped to define a storage space that contains a liquid, wherein the container is detachably coupled to the main body; a wick that is elongated and disposed inside the container, wherein the wick includes a portion that is in communication with the liquid contained in the storage space; a first coil wound around at least a portion the wick and along a longitudinal direction of the wick; and a second coil disposed at the main body and positioned relative to the first coil, wherein the second coil is configured to inductively heat the first coil.

### TECHNICAL FIELD

The following description relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component, and the like. Recently, active research has been conducted on the aerosol generating device.

### DISCLOSURE

### Technical Problem

It is an objective of the present disclosure to solve the above and other problems.

It is another objective of the present disclosure to provide an aerosol generating device in which a container for storing an aerosol generating material is replaceable.

It is another objective of the present disclosure to provide a structure for electrically connecting a power source and the container.

It is another objective of the present disclosure to effectively heat a susceptor in the container by induction heating.

### Technical Solution

In accordance with an aspect of the present disclosure for accomplishing the above objectives, there is provided an aerosol generating device including: a main body; a container shaped to define a storage space that contains a liquid, wherein the container is detachably coupled to the main body; a wick that is elongated and disposed inside the container, wherein the wick includes a portion that is in communication with the liquid contained in the storage space; a first coil wound around at least a portion the wick and along a longitudinal direction of the wick; and a second coil disposed at the main body and positioned relative to the first coil, wherein the second coil is configured to inductively heat the first coil.

### Advantageous Effects

According to at least one of the embodiments of the present disclosure, a manufacturing process of an aerosol generating device may be simplified by removing an electrical connection structure between a power source and a container.

According to at least one of the embodiments of the present disclosure, stability of an aerosol generating device may be improved by removing an electrical connection structure between a power source and a container.

According to at least one of the embodiments of the present disclosure, a coil for heating a susceptor may be formed as a pan coil, such that the susceptor in the container may be effectively heated by induction heating.

According to at least one of the embodiments of the present disclosure, by applying a pan coil having a shape corresponding to a shape of the susceptor, the susceptor in the container may be effectively heated by induction heating.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### DESCRIPTION OF DRAWINGS

FIGS. 1 to 12 are diagrams illustrating examples of an aerosol generating device according to an embodiment of the present disclosure.

### MODE FOR INVENTION

Hereinafter, embodiments of the present disclosure will be described in detail with reference to the accompanying drawings, in which the same or similar elements are designated by the same reference numerals, and a redundant description thereof will be omitted.

The terms “module” and “unit” for elements used in the following description are given simply in view of the ease of the description, and do not have a distinguishing meaning or role.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings, and the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms are intended to include the plural forms as well, unless the context clearly indicates otherwise.

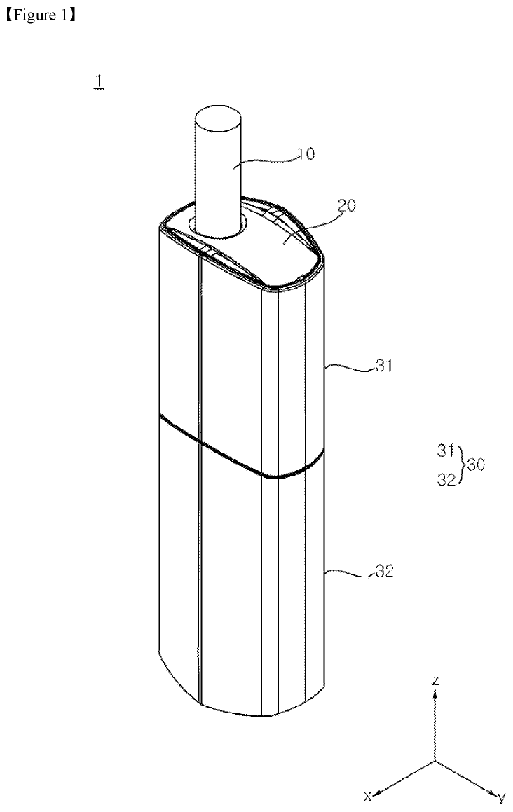

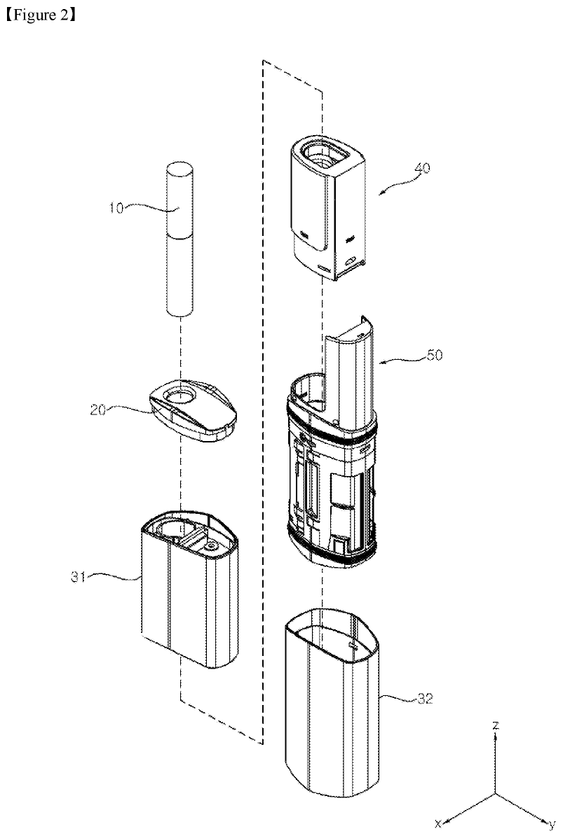

FIG. 1 is a perspective view of an aerosol generating device 1 according to an embodiment of the present disclosure. FIG. 2 is an exploded perspective view of the aerosol generating device 1 of FIG. 1.

Referring to FIGS. 1 and 2, the aerosol generating device 1 includes: a casing 30 including an upper part 31 and a lower part 32; a cap 20 coupled to the upper part 31; a container 40 which is disposed in the casing 30 and in which aerosol is generated; and a main body 50 which is disposed in the casing 30 and to which the container is mounted. A stick 10 may be inserted into the aerosol generating device 1 through the cap 20.

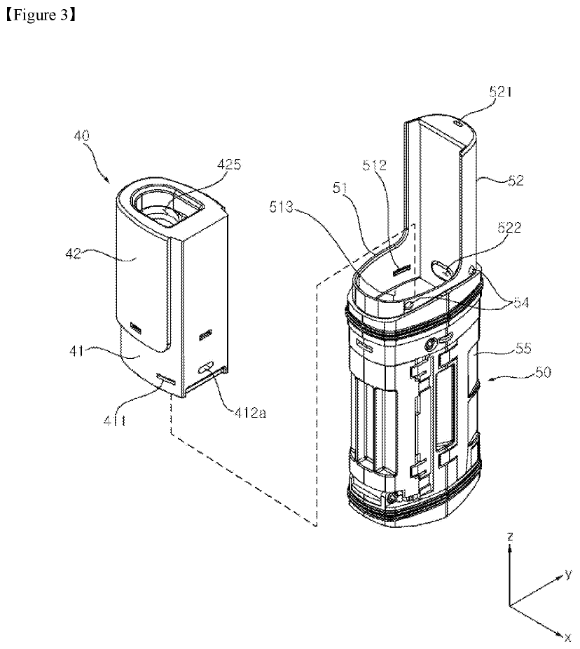

The casing 30 may form the exterior of the aerosol generating device 1 along with the cap 20. The casing 30 may include the upper part 31 and the lower part 32. The upper part 31 and the lower part 32 may surround a circumference of the aerosol generating device 1. The container 40 and the main body 50 may be disposed in the casing 30. An inner surface of the lower part 32 may be coupled to a protrusion 54 (see FIG. 3) of the main body 50. An outer surface of the upper part 31 and an outer surface of the lower part 32 may form a continuous surface. A user may hold the aerosol generating device 1 by gripping an outer surface of the casing 30.

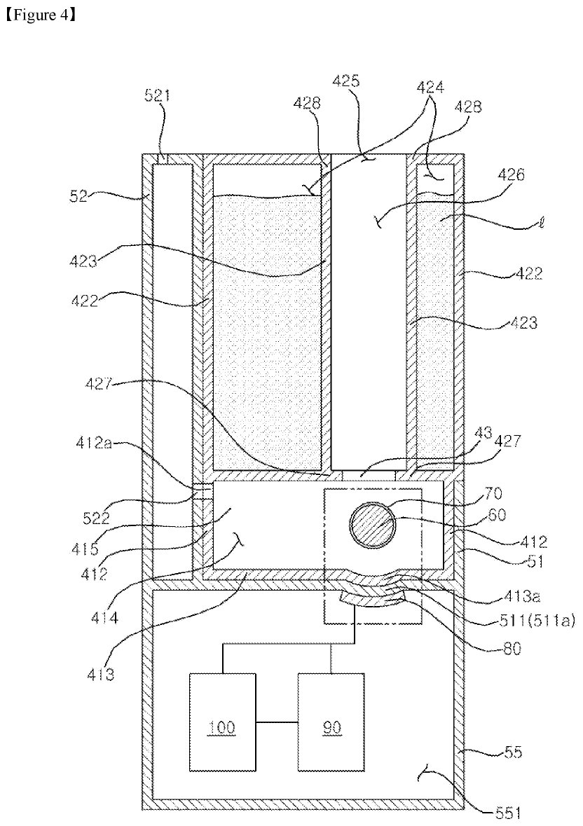

The cap 20 may have a hole through which the stick 10 is inserted. The cap 20 may be coupled to the upper part 31. The hole of the cap 20 may communicate with an insertion space 426 (see FIG. 4) into which the stick 10 is inserted. The upper part 31 may be disposed between the cap 20 and the lower part 32.

Aerosol may be generated in the container 40. The container 40 may be detachably coupled to the main body 50. The container 40 and the main body 50 may be coupled to each other by forced coupling. The container 40 may have an elongated shape. An opening 425 (see FIG. 3), through which the stick 10 is inserted, may be formed at one end of the container. The container 40 may be partially covered by the casing 30.

Electronic components, such as a battery 100 (see FIG. 4), a Printed Circuit Board (PCB), etc., may be installed in the main body 50. When the container 40 is mounted to the main body 50, the main body 50 may have a shape which is elongated in a longitudinal direction of the container. The main body 50 may be partially covered by the casing 30.

FIGS. 3 and 4 are diagrams illustrating the container 40 and the main body 50 according to an embodiment of the present disclosure. Referring to FIGS. 3 and 4, the aerosol generating device 1 according to an embodiment of the present disclosure includes the container 40, the main body 50, a wick 60, a first coil 70, a second coil 80, a controller 90, and a power source 100.

The container 40 includes a first part 42, a second part 41, and a stopper 43. Aerosol may be generated in the container 40. The container 40 may contain a liquid 1. The container 40 may have a flow path formed therein.

The first part 42 may include an outer wall 422, an inner wall 423, a storage space 424, and an insertion space 426. The inner wall 423 of the first part 42 may have one end 427 and another end 428 which are open. The inner wall 423 of the first part 42 may have an insertion space 426 formed therein. The inner wall 423 of the first part 42 may be elongated in the longitudinal direction of the container 40. The outer wall 422 of the first part 42 may surround the inner wall 423 of the first part 42. The outer wall 422 of the first part 42 may form at least a portion of an outer surface of the container 40. At least a portion of the storage space 424 may be formed between the inner wall 423 and the outer wall 422 of the first part 42. At least a portion of the storage space 424 may be formed between the inner wall 415 of the second part 41 and the outer wall 422 of the first part 42.

An aerosol generating material 1 may be stored in the storage space 424. The aerosol generating material 1 may be in a liquid state at room temperature. The aerosol generating material 1 may be referred to as a liquid-type material.

The stick 10 may be inserted into the insertion space 426. The insertion space 426 may communicate with the outside of the aerosol generating device 1. The stick 10 may be inserted into the insertion space 426 through the opening 425. The insertion space 426 may be formed inside the inner wall 423 of the first part 42. The insertion space 426 may be elongated along the inner wall 423.

The second part 41 may be connected to one end of the first part 42. The second part 41 may be integrally formed with the first part 42. The second part 41 may include an inner wall 415, a lateral wall 412, a bottom 413, a groove 411, and a flow space 414.

The inner wall 415, the lateral wall 512, and the bottom 413 of the second part 41 may define the flow space 414 therein. An inlet 412a for allowing the flow space 414 to communicate with the outside of the container 40 may be formed in the lateral wall 412 of the second part 41.

The inner wall 415 of the second part 41 may be connected to the inner wall 423 of the first part 42. The inner wall 415 of the second part 41 may be integrally formed with the inner wall 423 of the first part 42. The lateral wall 412 of the second part 41 may be connected to the outer wall 422 of the first part 42. The lateral wall 412 of the second part 41 may be integrally formed with the outer wall 422 of the first part 42.

The inlet 412a may communicate with through-holes 521 and 522 of a column 52. Air introduced into the inlet 412a through the through-holes 521 and 522 may sequentially pass through the flow space 414 and the insertion space 426 to flow to the outside of the container 40.

The bottom 413 of the second part 41 may connect the inner wall 415 and the lateral wall 412 of the second part 41. The bottom 413 may have a recessed portion 413a. A portion of the bottom 413 may face the opening 425 of the first part 42. The recessed portion 413a may be formed in an inner surface of the bottom 413. Liquid leaking from the wick 60 may be held in the recessed portion 413a. The recessed portion 413a may face the wick 60. The recessed portion 413a may face the opening 425. The recessed portion 413a may be curved with a predetermined curvature to be recessed.

The main body 50 includes a mount 51, a column 52, a protrusion 54, and a housing 55. A power source 100 may be disposed in the main body 50. The controller 90 and the second coil 80, which are electrically connected to the power source 100, may be installed in the main body 50.

The mount 51 may be disposed in the housing 55. The mount 51 may protrude from the housing 55. Unlike the example, the mount 51 may be formed by recessing a portion of an outer surface of the housing 55. The mount 51 may have an installation space 513 in which the container 40 is disposed. The mount 51 may be connected to the column 52.

The mount 51 may include a facing surface 511 that faces the bottom 413 of the second part 41 of the container 40. The facing surface 511 may have a recessed portion 511a. The recessed portion 511a of the facing surface 511 may have a shape corresponding to the recessed portion 413a of the second part 42 of the container 40. The second coil 80 may have a shape corresponding to the recessed portion 511a of the facing surface 511 and the recessed portion 413a of the second part 42.

The recessed portion 511a of the facing surface 511 may be recessed in the same direction as that of the recessed portion 413a of the second part 42 of the container 40. The recessed portion 511a of the facing surface 511 may be curved with a predetermined curvature to be recessed.

The column 52 may be elongated outwardly from the housing 55. The column 52 may have a hollow shape. The column 52 may support the container 40 disposed in the installation space 513. The column 52 may support the outer wall 522 of the first part 42 of the container 40. The column 52 may support the lateral wall 412 of the second part 41 of the container 40. The column 52 may have the through-holes 521 and 522 for communicating the inside and outside of the column 52. The through-hole 521 may communicate with the outside of the aerosol generating device 1. The through-hole 521 may be disposed at one end of the column 52.

The housing 55 may have a mounting space 551 formed therein. The power source 100, the controller 90, and the second coil 80 may be disposed in the mounting space 551. The power source 100 may be electrically connected to the controller 90 and the second coil 80. The controller 90 may control power supplied from the power source 100 to the second coil 80. The power source 100 may be a rechargeable battery or a disposable battery. For example, the power source 100 may be a lithium polymer (LiPoly) battery but is not limited thereto.

The wick 60 may be partially disposed in the storage space 424. The wick 60 may absorb the liquid 1. The wick 60 may be made of a porous material. The wick 60 may pass through the inner wall 415 of the second part 41 to be connected or extend to the liquid 1. The wick 60 may be elongated. The wick 60 may have a cylindrical shape. The wick 60 may have a circular cross-section.

The first coil 70 may be wound a plurality of times around the wick 60. The first coil 70 may be disposed around the wick 60. The first coil 70 may come into contact with the wick 60. The first coil 70 may be wound around the wick 60 in a longitudinal direction of the elongated wick 60. The first coil 70 may be referred to as a susceptor coil.

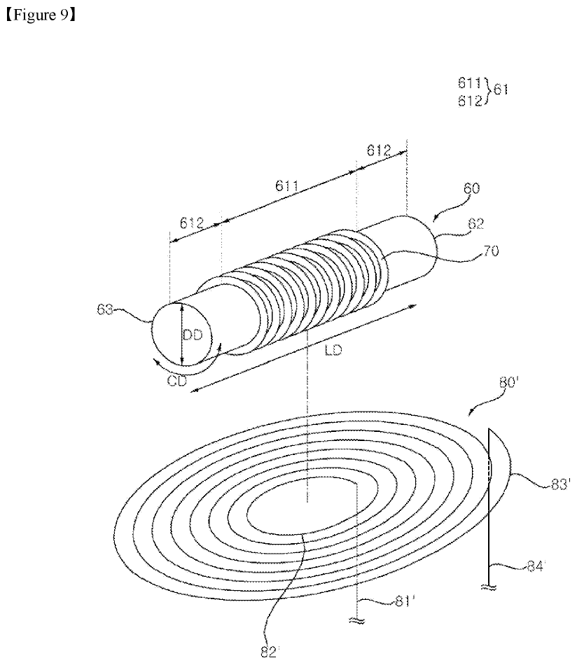

The second coil 80 may be disposed in the main body 50. The second coil 80 may be disposed in the housing 55. The second coil 80 may be disposed adjacent to the first coil 70. The opening 425, the insertion space 426, the first coil 70, and the second coil 80 may be sequentially arranged. The second coil 80 may be formed as a pan coil (see FIG. 9) having a plurality of turns. The power source 100 may apply an alternating current (AC) voltage to the second coil 80. The second coil 80 may generate an induced magnetic field. The induced magnetic field generated by the second coil 80 may pass through the first coil 70. The first coil 70 may be inductively heated by the second coil 80. The second coil 80 may be referred to as a heating coil.

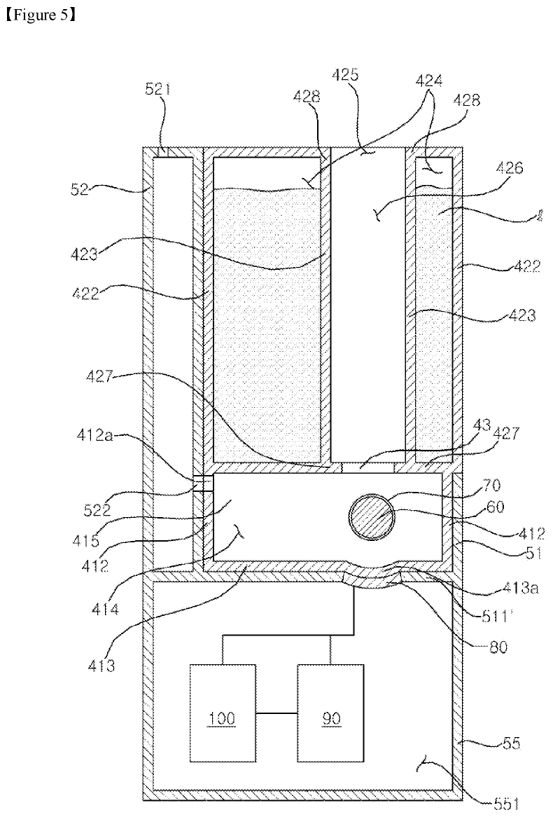

FIG. 5 is a diagram illustrating an aerosol generating device according to an embodiment of the present disclosure. Referring to FIGS. 4 and 5, the second coil 80 may be mounted on the mount 51. The second coil 80 may be disposed on a bottom 511′ of the mount 51. Unlike the aerosol generating device 1 illustrated in FIG. 4, the first coil 70 and the second coil 80 may be disposed closer to each other. Accordingly, the number of magnetic field lines, induced by the second coil 80 and passing through the first coil 70, increases such that the first coil 70 may be effectively heated by induction heating.

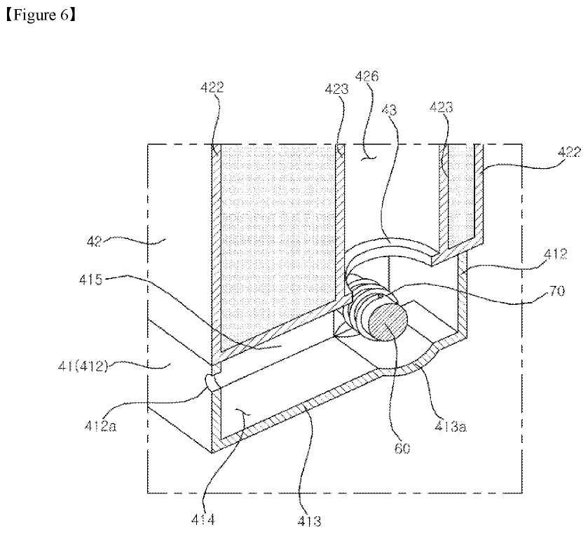

FIG. 6 is a diagram illustrating the inside of the container 40 according to an embodiment of the present disclosure. The container 40 may include the stopper 43. The stopper 43 may protrude from the inner wall 423 of the first part 42 toward the insertion space 426. The stopper 43 may support the stick 10 inserted into the insertion space 426. The stopper 43 may be disposed at the one end 427 of the inner wall 423 of the first part 42. The stopper 43 may be disposed between the insertion space 426 and the flow space 414.

The stopper 43 may be formed in a ring shape. The stopper 43 may extend along the inner wall 423 of the first part 42. The stopper 43 may extend in a direction intersecting a longitudinal direction of the inner wall 423 of the first part 42. For example, the stopper 43 may extend in a direction orthogonal to the longitudinal direction of the inner wall 423 of the first part 42.

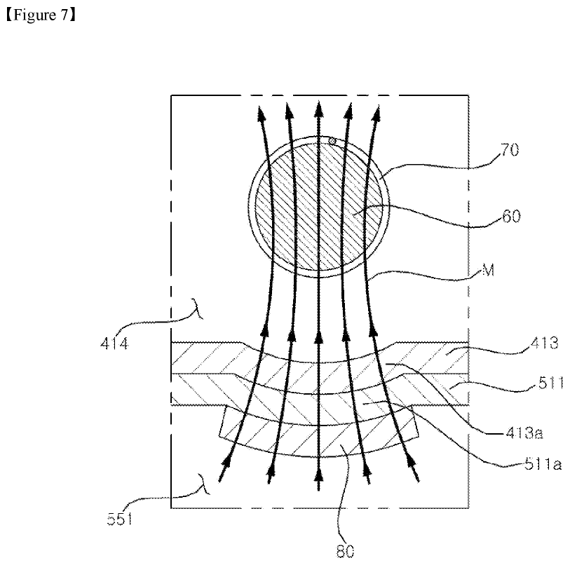

FIG. 7 is a diagram illustrating an induced magnetic field M generated by the second coil 80 according to an embodiment of the present disclosure. Referring to FIG. 7, the power source 100 may generate the induced magnetic field M by applying an AC voltage to the second coil 80. The generated induced magnetic field M may pass through the first coil 70 wound around the wick 60. The first coil 70 may be inductively heated by the induced magnetic field M.

The second coil 80 may be disposed to face the wick 60. The second coil 80 may be curved to correspond to a predetermined curvature of the recessed portions 413a and 511a. The induced magnetic field M generated by the curved second coil 80 may be more concentrated on the first coil 70. Accordingly, the second coil 80 may effectively heat the first coil 70 by induction heating.

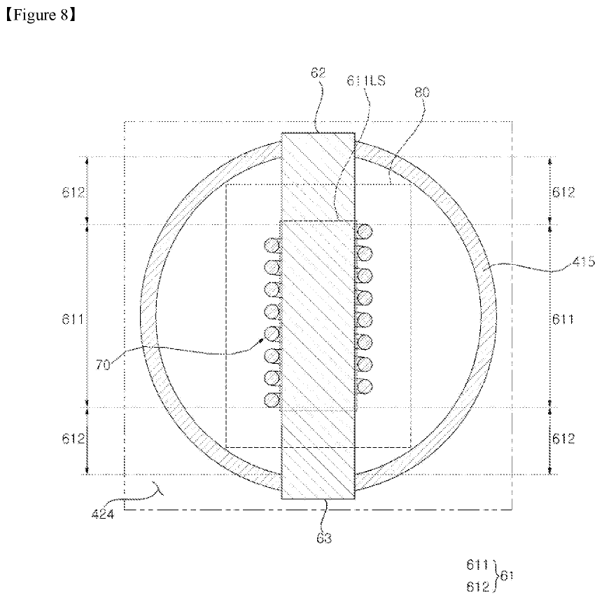

FIG. 8 is a diagram illustrating a portion of the aerosol generating device 1 according to an embodiment of the present disclosure. Referring to FIG. 8, the second coil 80 may have a shape corresponding to a longitudinal section 611LS of a portion of the wick 60.

The wick 60 may have a winding portion 611, around which the first coil 70 is wound, and an unwinding portion 612 around which the first coil 70 is unwound. The wick 60 may be elongated. The wick 60 may be elongated with both ends 62 and 63 which are disposed in the storage space 424. The unwinding portion 612 of the wick 60 may be formed on each of both sides of the wick 60.

The winding portion 611 may be positioned in the middle of the unwinding portion 612 of the wick 60. The winding portion 611 of the wick 60 and the second coil 80 may be sequentially arranged in the longitudinal direction of the container 40. The second coil 80 may have a shape corresponding to the longitudinal section 611LS of the winding portion 611 in the longitudinal direction of the wick 60. A size of the second coil 80, facing the longitudinal section 611LS of the winding portion 611, may be greater than the longitudinal section 611LS of the winding portion 611.

Accordingly, the second coil 80 may effectively heat the first coil 70, wound around the winding portion 611, by induction heating.

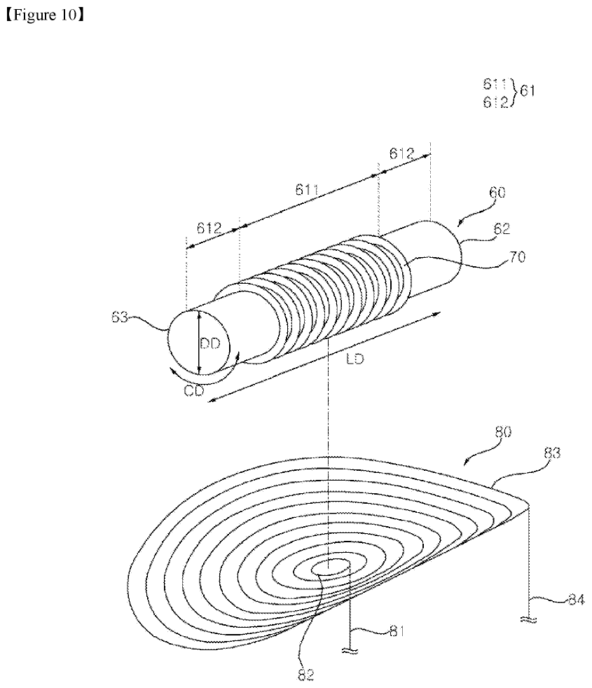

FIGS. 9 and 10 are diagrams illustrating the wick 60, the first coil 70, and second coils 80 and 80′ according to an embodiment of the present disclosure. FIGS. 9 and 10 illustrate different examples of a portion of an aerosol generating device. Referring to FIGS. 9 and 10, the second coils 80 and 80′ may be spaced apart from the wick 60 in a direction intersecting a longitudinal direction LD of the wick 60. The second coils 80 and 80′ may be spaced apart from the wick 60 in a diameter direction DD of the wick 60.

The second coil 80 may be wound with a plurality of turns from an innermost turn 82 to an outermost turn 83. The second coil 80 may include a first wire 81 connecting the innermost turn 82 to the power source 100, and a second wire 84 connecting the outermost turn 83 to the power source 100.

The second coil 80′ may be wound with a plurality of turns from an innermost turn 82′ to an outermost turn 83′. The second coil 80′ may include a third wire 81′ connecting the innermost turn 82′ to the power source 100, and a fourth wire 84′ connecting the outermost turn 83′ to the power source 100.

The second coil 80′ may be curved in a circumferential direction CD of the wick 60. The second coils 80 and 80′ may face a portion 61 of an outer surface of the wick 60. The second coils 80 and 80′ may face the outer circumferential surface 61 of the wick 60. The second coils 80 and 80′ may be curved to correspond to the outer circumferential surface 61 of the wick 60. The second coil 80′ may have a shape extending in the longitudinal direction LD of the wick 60. Accordingly, the second coil 80′, having a shape corresponding to the wick 60, may effectively heat the first coil 70 by induction heating.

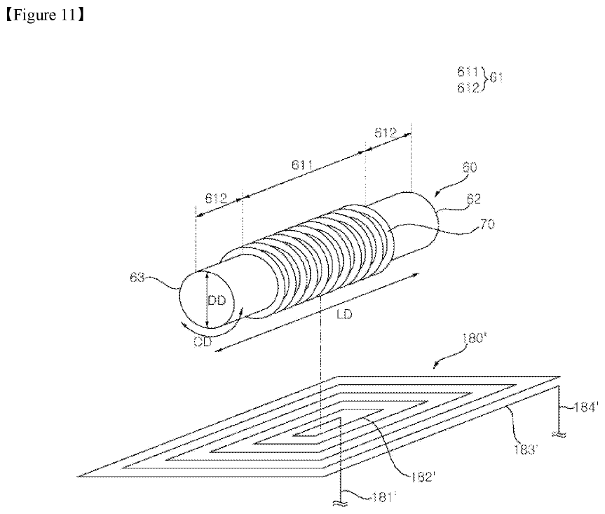

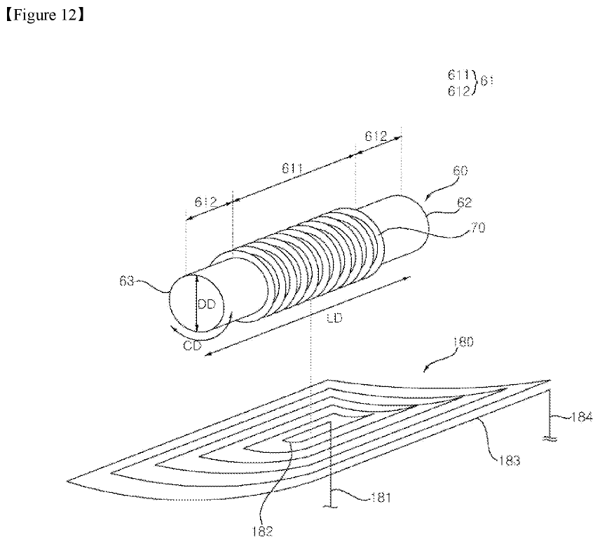

FIGS. 11 and 12 are diagrams illustrating the wick 60, the first coil 70, and second coils 180 and 180′. FIGS. 11 and 12 illustrate different examples of a portion of an aerosol generating device. Referring to FIGS. 11 and 12, the second coils 180 and 180′ may be spaced apart from the wick 60 in a direction intersecting the longitudinal direction LD of the wick 60. The second coils 180 and 180′ may be spaced apart from the wick 60 in the diameter direction DD of the wick 60.

The second coil 180 may be wound with a plurality of turns from an innermost turn 182 to an outermost turn 183. The second coil 180 may include a fifth wire 181 connecting the innermost turn 182 to the power source 100, and a sixth wire 184 connecting the outermost turn 183 to the power source 100.

The second coil 180′ may be wound with a plurality of turns from an innermost turn 182′ to an outermost turn 183′. The second coil 180′ may include a seventh wire 181′ connecting the innermost turn 182′ to the power source 100, and an eighth wire 184′ connecting the outermost turn 183′ to the power source 100.

The second coil 180′ may be curved in the circumferential direction CD of the wick 60. The second coils 180 and 180′ may face the outer circumferential surface 61 of the wick 60. The second coil 180′ may be curved to correspond to the outer circumferential surface 61 of the wick 60. The second coil 180′ may have a shape extending in the longitudinal direction LD of the wick 60. Accordingly, the second coil 180′, having a shape corresponding to the wick 60, may effectively heat the first coil 70 by induction heating.

The second coils 180 and 180′ may have a rectangular shape. The longitudinal section 611LS of the winding portion 611 of the wick 60 of a cylindrical shape may have a rectangular shape, and the second coils 180 and 180′ may have a rectangular shape to correspond to the longitudinal section 611LS of the winding portion 611. Accordingly, the first coil 70, wound around the winding portion 611, may be effectively heated by induction heating.

The second coils 80, 80′, 180, and 180′ facing the outer circumferential surface 61 of the wick 60 may indicate that the magnetic field, generated by the second coils 80, 80′, 180, and 180′, passes through the wick 60 and the first coil 70 as illustrated in FIG. 7. FIGS. 9 to 12 illustrate an example in which the second coils 80, 80′, 180, and 180′ face the outer circumferential surface 61 of the wick 60.

Referring to FIGS. 1 to 12, an aerosol generating device 1 according to an embodiment of the present disclosure includes: a main body 50; a container 40 in which a liquid 1 is contained, and which is detachably coupled to the main body; a wick 60 disposed in the container 40 and elongated with a portion connected or extending to the liquid 1; a first coil 70 wound around the wick 60 in a longitudinal direction of the wick 60; and a second coil 80 disposed in the main body 50 and inductively heating the first coil 70.

According to another embodiment of the present disclosure, the container 40 may include: inner walls 423 and 415 elongated with a portion 423 that defines an insertion space 426 therein; and an outer wall 422 surrounding the inner walls 423 and 415 such that a storage space 424, in which the liquid is contained, is formed between the outer wall 422 and the inner walls 423 and 415.

According to another embodiment of the present disclosure, the container 40 may include: a first part 42 having the inner wall 423 elongated with one end 427 and another end 428 which are open, and defining the insertion space 426 therein; and a second part 41 connected to the one end of the first part 42 and defining a flow space 414 therein for allowing the inner wall 415 to communicate with the insertion space 426, wherein the wick 60 may pass through the inner wall 415 of the second part 41 to be connected to the storage space 424.

According to another embodiment of the present disclosure, the aerosol generating device 1 may further include a stopper 43 protruding from the inner wall 423 of the first part 42 toward the insertion space 426, and disposed adjacent to the one end of the first part 42 adjacent to the wick 60.

According to another embodiment of the present disclosure, the container 40 may further include an inlet 412a formed in the outer wall 422 of the container 40 and allowing the flow space 414 to communicate with an outside of the container 40.

According to another embodiment of the present disclosure, the main body 50 may include: a housing 55 accommodating a power source 100 electrically connected to the second coil 80; and a mount 51 disposed in the housing 55, detachably coupled to the container 40, and having the second coil 80 disposed thereon.

According to another embodiment of the present disclosure, the wick 60 may be elongated with a first end 62 and a second end 63 and may include the outer circumferential surface 61 connecting the first end 62 and the second end 63, wherein the second coil 80 may be formed as a pan coil wound with a plurality of turns from an innermost turn 82 to an outermost turn 83 and may face the outer circumferential surface 61 of the wick 60.

According to another embodiment of the present disclosure, the second coil 80 may be spaced apart from a portion 611 of the outer circumferential surface 61 of the wick 60, around which the first coil 70 is wound, in a direction DD intersecting a longitudinal direction LD of the wick 60.

According to another embodiment of the present disclosure, the second coil 80 may have a shape corresponding to a longitudinal section 611LS of the portion 611 of the wick 60 around which the first coil 70 is wound.

According to another embodiment of the present disclosure, the wick 60 may be formed in a cylindrical shape, wherein the second coil 80 may be curved in a circumferential direction CD of the wick 60 to correspond to the outer circumferential surface 61 of the wick 60.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol generating device comprising:
a main body;
a container shaped to define a storage space that contains a liquid, wherein the container is detachably coupled to the main body;
a wick that is elongated and disposed inside the container, wherein the wick includes a portion that is in communication with the liquid contained in the storage space;
a first coil wound around at least a portion the wick and along a longitudinal direction of the wick; and
a second coil disposed at the main body and positioned relative to the first coil, wherein the second coil is configured to inductively heat the first coil.

2. The aerosol generating device of claim 1, wherein the container comprises:
an inner wall that is elongated and includes a portion that is shaped to define an insertion space; and
an outer wall surrounding the inner wall, wherein the outer wall and the inner wall define the storage space that contains the liquid.

3. The aerosol generating device of claim 2, wherein the container comprises:
a first part having the inner wall elongated with one end and another end which are both shaped to define an opening; and
a second part having an inner wall and being coupled to the one end of the first part and shaped to define a flow space therein for allowing communication with the insertion space,
wherein the wick passes through the inner wall of the second part to communicate with the liquid contained in the storage space.

4. The aerosol generating device of claim 3, further comprising a stopper protruding from the inner wall of the first part toward the insertion space, and disposed adjacent to the one end of the first part adjacent to the wick.

5. The aerosol generating device of claim 3, wherein the second part includes a lateral wall that is coupled to the inner wall of the second part and is shaped to define an inlet that allows the flow space to communicate with an outside of the container.

6. The aerosol generating device of claim 1, wherein the main body comprises:
a housing accommodating a power source electrically connected to the second coil; and
a mount disposed at the housing, detachably coupled to the container, and having the second coil disposed thereon.

7. The aerosol generating device of claim 1, wherein the wick is elongated with a first end and a second end, and has an outer circumferential surface connecting the first end and the second end,
wherein the second coil is formed as a pan coil wound with a plurality of turns from an innermost turn to an outermost turn and faces the outer circumferential surface of the wick.

8. The aerosol generating device of claim 7, wherein the second coil is spaced apart from a portion of the outer circumferential surface of the wick, around which the first coil is wound, in a direction intersecting a longitudinal direction of the wick.

9. The aerosol generating device of claim 8, wherein the second coil has a shape corresponding to a longitudinal section of the portion of the wick around which the first coil is wound.

10. The aerosol generating device of claim 7, wherein the wick is formed in a cylindrical shape, and
wherein the second coil is curved in a circumferential direction of the wick to generally correspond to the outer circumferential surface of the wick.

11. An aerosol generating device comprising:
a main body;
a power source located in the main body;
a container shaped to define a storage space that contains a liquid, wherein the container is detachably coupled to the main body;
a wick that includes a portion that is in communication with the liquid contained in the storage space;
a first coil wound around at least a portion of the wick and along a longitudinal direction of the wick;
a second coil disposed at the main body and being in electrical communication with the power source, wherein the second coil is positioned relative to the first coil; and
a controller configured to control power supplied by the power source to the second coil to cause the second coil to generate an induced magnetic field that passes through the first coil and heats the first coil.

12. The aerosol generating device of claim 11, wherein the container comprises:
a first part having an inner wall elongated with one end and another end which are both shaped to define an opening; and
a second part having an inner wall and being positioned relative to the one end of the first part and shaped to define a flow space therein for allowing communication with an insertion space,
wherein the wick passes through the inner wall of the second part to communicate with the liquid contained in the storage space.

13. The aerosol generating device of claim 11, wherein the wick is formed in a cylindrical shape, and
wherein the second coil is curved in a circumferential direction of the wick to generally correspond to an outer circumferential surface of the wick.
